(19) United States
(12) Patent Application Publication
(10) Pub. No.: US 2006/0147007 A1
(43) Pub. Date: Jul. 6, 2006

(54) Method and system for providing education-on-demand service

(75) Inventors: Sang-ho Lee, Seoul (KR); Kyle Kim, Suwon-si (KR); In-ho Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/293,362

(22) Filed: Dec. 5, 2005

(30) Foreign Application Priority Data
Dec. 16, 2004 (KR) 10-2004-0106845

(51) Int. Cl. H04M 3/42

(52) U.S. Cl. 379/201.04

(57) ABSTRACT

A system for providing contents having different difficulty levels according to a learning ability of a customer. The system includes a home server for determining one difficulty level according to the learning ability calculated from brain waves of a customer. The learning ability may include a concentration level of the customer. The system also includes a service provider for providing content corresponding to the determined difficulty level among contents having at least two difficulty levels, and a home device for receiving content from the service provider.

### CROSS-REFERENCE TO RELATED APPLICATIONS

This application claims priority from Korean Patent Application No. 2004-106845, filed on Dec. 16, 2004, the entire content of which is incorporated herein by reference.

### BACKGROUND OF THE INVENTION

1. Field of the Invention

The present invention relates to an Education-on-Demand (EOD) service. More specifically, the invention relates to a method of and system for providing an EOD service, which can provide EOD services differentiated according to the comprehension and concentration levels of customers.

2. Description of the Related Art

Conventionally, customers are provided with one-sided services only by receiving contents from a provider regardless of their needs. The Internet grows and expands very fast and provides categorized services to customers. A distance education service is a method to provide a convenient and efficient educational environment through the Internet. Accordingly, user-oriented educational environment becomes one of the biggest issues, in which the customer can take lessons whenever and wherever is convenient to thereby provide an educational form capable of overcoming many conventional limitations. Through the growth of the Internet and the development of high-speed networks, many types of services based on user-oriented education have been continuously researched. The conventional educational environment is mainly established within the time and space limitations between an instructor and a customer, and its uniform education, not considering the learning ability of each customer, embraces many problems. That is, due to a characteristic of the Internet, the number of customers participating in the distance education increases, and thus different customers request different services. Therefore, the provided service should meet the Quality of Service (QoS) for the user-requesting services.

An EOD service is an example of an educational service using a distance learning method. The EOD service is an interactive service that provides desired video data composed of images and sounds to customers at a desired time. In addition, the EOD service is provided according to the customers' request to thereby give an opportunity for re-education without limitation in the instruction time.

The EOD service can be provided to a plurality of customers simultaneously by using one multimedia server or a plurality of multimedia servers. In other words, a service provider stores instructions in the multimedia server in advance and registered customers are provided with a desired instruction using a computer at a desired time. Questions about the instructions can be sent using an e-mail. That is, in the EOD service, the user can select not only an instruction item, but also the start and the end of the instruction.

FIG. 1 illustrates a conventional system for providing the EOD service to a customer. The system comprises an EOD providing server and a plurality of customers. Referring to FIG. 1, only a contents pool 100 for storing contents is illustrated as a server, while a plurality of customers is composed of customers 1 to n.

The contents pool 100 is composed of contents A to G. Contents stored in the contents pool 100 can be modified or added by the selection of a service provider or at the request of a customer.

Referring to FIG. 1, customer 1 and customer 2 learn content A and content B respectively received from the contents pool 100. Customer 3 and customer 4 learn content A and content B respectively received from the contents pool 100. In addition, customer 5 and customer n learn content C and content G respectively received from the contents pool 100.

As shown in FIG. 1, customer 1 and customer 3 learn content A received from the contents pool 100, while customer 2 and customer 4 learn content B received from the contents pool 100. However, customer 1 and customer 3 may have different learning abilities from each other. Moreover, customer 2 and customer 4 may also have different learning abilities from each other. In addition, customers 1 to n have to keep learning for a certain period of time even if the current learning contents are not satisfactory. That is, in the case where content having an inappropriate difficulty level is provided, the customer may not be satisfied with the current contents. Therefore, a method is needed that is capable of providing contents conforming to the learning ability of the customer.

### SUMMARY OF THE INVENTION

The present invention provides a method and system for an EOD service that can conform to the learning ability of the customer.

The present invention also provides a method and system for an EOD service, in which contents conforming to the learning ability of the customer are provided, thereby improving learning efficiency.

According to an aspect of the invention, there is provided a method of providing contents in an EOD service system, which includes a contents provider for providing contents and a home device for receiving contents from the contents provider. The method comprises: according to a learning ability calculated from the brain waves of a customer, determining one difficulty level among the contents having at least two difficulty levels, the learning ability including a concentration level; and transmitting contents corresponding to the determined difficulty level to the home device.

In addition, according to another aspect of the invention, there is provided an EOD service, which comprises a home server for determining one difficulty level according to a concentration level calculated from brain waves of the customer; a service provider for providing contents corresponding to the determined difficulty level by the home server among more than two contents stored in the server; and a home device for receiving contents from the service provider.

### BRIEF DESCRIPTION OF THE DRAWINGS

FIG. 1 is a schematic diagram of a conventional EOD service;

FIG. 2 is a schematic diagram of an EOD service system according to an exemplary embodiment of the invention;

FIG. 3 is a flow chart explaining a process for generating a difficulty level signal according to an exemplary embodiment of the invention;

FIG. 4 is a flow chart explaining a process for adjusting the difficulty level by the difficulty level signal according to an exemplary embodiment of the invention; and

FIG. 5 is a block diagram showing the structure of the EOD service system according to an exemplary embodiment of the invention.

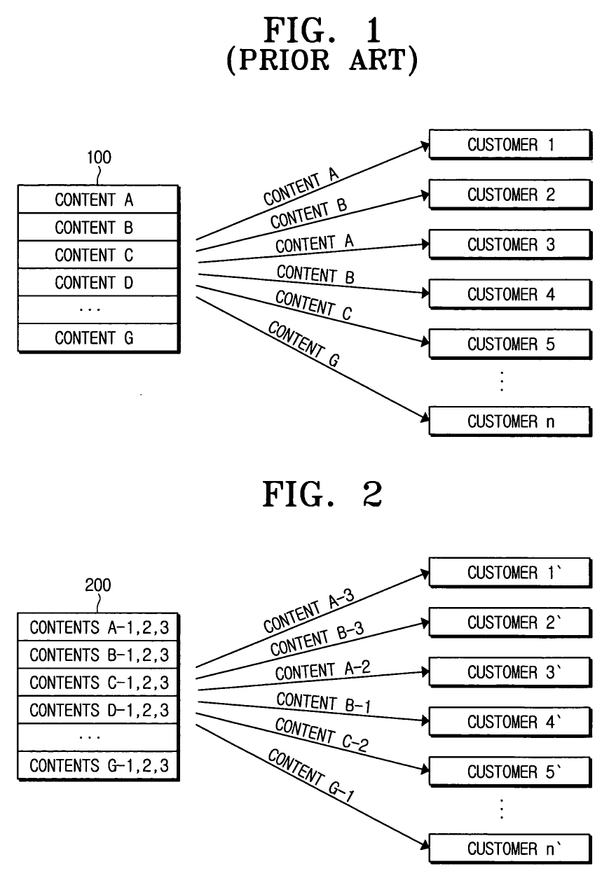

### DETAILED DESCRIPTION OF THE EXEMPLARY EMBODIMENTS

Certain exemplary embodiments of the present invention will be described in greater detail with reference to the accompanying drawings.

An exemplary embodiment of the present invention proposes a method of providing contents having different difficulty levels according to the learning ability of the customer.

FIG. 2 shows a system for providing an EOD service to a customer according to an embodiment of the invention. The system comprises a server for providing the EOD service, and a plurality of customers. Referring to FIG. 2, only a contents pool 200 for storing contents is illustrated as a server, while a plurality of customers are composed of customers 1′ to n′.

The contents pool 200 is composed of content A to content G. Contents stored in the contents pool 100 can be modified or added by the selection of a service provider or the request of a customer. In addition, all the contents have various difficulty levels. That is, content A may be composed of content A-1, content A-2 and content A-3 each having a different difficulty level. In FIG. 2, each of the contents is illustrated to have three difficulty levels, while the number of the difficulty levels can vary according to the setting of a provider. In other words, a service provider can provide contents having at least two difficulty levels.

For example, it can be assumed that content A-1 has the lowest difficulty level and content A-3 has the highest difficulty level. All contents are illustrated to have three difficulty levels in FIG. 2. However, the number of difficulty levels can vary according to the setting by the service provider.

Referring to FIG. 2, customer 1′ and customer 2′ learn content A-3 and content B-3 respectively received from the contents pool 200. Customer 3′ and customer 4′ learn content A-2 and content B-1 respectively received from the contents pool 200. In addition, customer 5′ and customer n′ learn content C-2 and content G-1 respectively received from the contents pool 100.

As described above, customer 1′ and customer 3′ learn content A each having a different difficulty level. In addition, customer 2′ and customer 4′ also learn content B each having a different difficulty level. In this manner, customers can learn content having difficulty levels corresponding to their learning abilities, instead of being provided with content having a uniform difficulty level.

The initial difficulty level provided to the customer for the first time can be set in a variety of ways. That is, the customer can receive basic information on the contents corresponding to each difficulty level, and set a desired difficulty level based on the received information. In addition, the service provider can provide contents having the lowest difficulty level or intermediate difficulty level, when the customer requests the learning of certain contents.

Hereafter, how the difficulty level is changed according to the learning ability of the customer will be described. The learning ability of the customer includes the comprehension and concentration level. It is clear that factors other than the comprehension and concentration level may be part of the learning ability. However, in the present invention, it will be explained focusing mainly on the comprehension and concentration level for the sake of convenience.

The comprehension level may mean the degree of a customer's understanding (the degree of learning) for the provided contents, while the concentration level may mean the degree of a customer's attention to the provided contents. The comprehension level can be measured from an answer for the question asked by the service provider at a certain regular intervals. That is, the service provider transmits one or more questions to the customer at regular intervals or at the end of a learning section, then measures the comprehension level by checking the correct answers for the transmitted questions. It is needless to say that the service provider can store the information on the comprehension level of the customer.

The concentration level represents the degree of a customer's attention to the provided contents. In general, the concentration level is high when the comprehension level for the currently provided contents is high. In addition, the concentration level is low when the comprehension level for the currently provided content is low.

The concentration level of the customer is measured by means of a bio-signal. That is, the concentration level of the customer is measured by using a brain wave as a bio-signal. In general, the brain wave is used for identifying the customer's character, propensity or mental state, or for the scientific measurement of concentration, endurance, attention, creativity or thought. Hereafter, the brain wave will be described in detail.

Generally, a brain wave can be divided into alpha (α), beta (β), theta (θ) and delta (δ) waves. An alpha wave has a frequency of 8 to 12 Hz and occurs during meditation (mentally stable condition) or a highly concentrated state. A beta wave has a frequency of 13 to 30 Hz and occurs during normal conversation or the active state of the whole body. A theta wave has a frequency of 4 to 7 Hz and occurs during the creative or the stress-relaxed state. A delta wave has a frequency of 1 to 3 Hz and occurs during the deep sleeping state. In addition to these waves, gamma waves are generated during stressed or excited states. Therefore, the alpha wave is used for measuring concentration.

The brain wave is measured by means of P300. P300 is a wave form of the brain wave occurring at 200 ms or later after a specific stimulus, and changes suddenly near 300 ms. P300 occurs when the visual or the auditory stimuli from outside are perceived, and does not occur when stimuli are not perceived. Therefore, the brain wave of the customer can be represented by the measured signal P300.

In addition, the concentration level can be measured by using the balance of the left and right brain waves. In general, the phase, frequency and amplitude of the left brain wave are similar with those of the right brain wave under highly concentrated conditions, while they are different under lowly concentrated conditions. Hereafter, how to change the difficulty level according to the concentration level of the customer will be described.

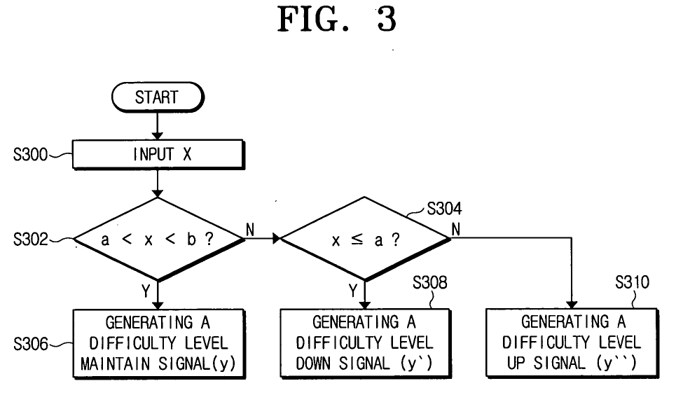

FIG. 3 is a flow chart showing a process for generating a difficulty level changing signal according to an exemplary embodiment of the invention, which is hereinafter described.

At operation S300, value X is input. The value X represents the concentration level corresponding to the measured brain wave. The concentration level is calculated using the brain wave of the customer. At operation S302, the input concentration level is determined if the value is between a and b. Both a and b values are set in the comparator, and can be modified by the service provider. If the input concentration level is found to be between a and b, the process moves to operation S306. Otherwise, the process moves to operation S304.

At operation S304, the comparator determines if the input concentration level X is smaller than or, equal to, a. If the input concentration level X is smaller than or equal to a, the process moves to operation S308. In addition, if the input concentration level X is greater than a, the process moves to operation S310.

At operations S306 and S308, the comparator generates and outputs the difficulty level maintain signal and the difficulty level down signal, respectively. In addition, at operation S310, the comparator generates and outputs the difficulty level up signal.

At operation S302, it is illustrated that only the transferred concentration level is used for comparison with the pre-determined a and b values, but it is also possible to consider the comprehension level of the customer according to the setup by the service provider. That is, the stored comprehension and concentration level of the each customer can be compared with the pre-determined a and b values.

In addition, an exemplary method of assigning the input comprehension level to one of three regions is shown in FIG. 3. That is, the input comprehension level can be assigned to one of at least three regions.

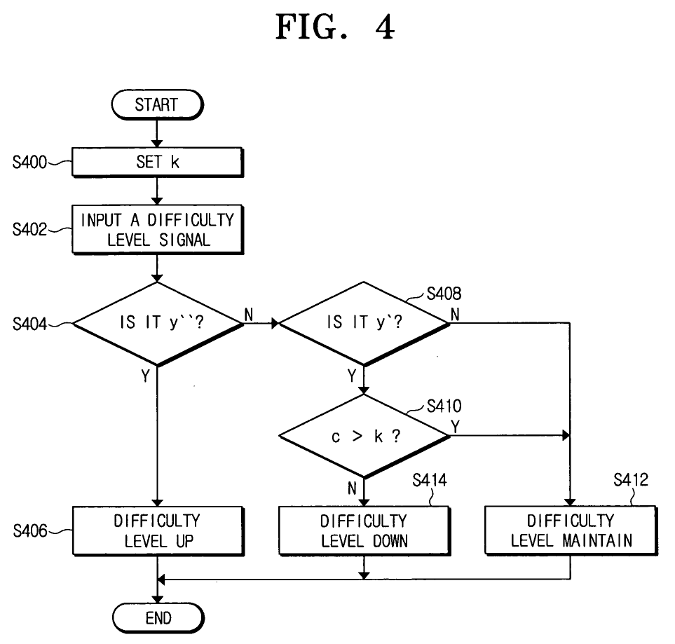

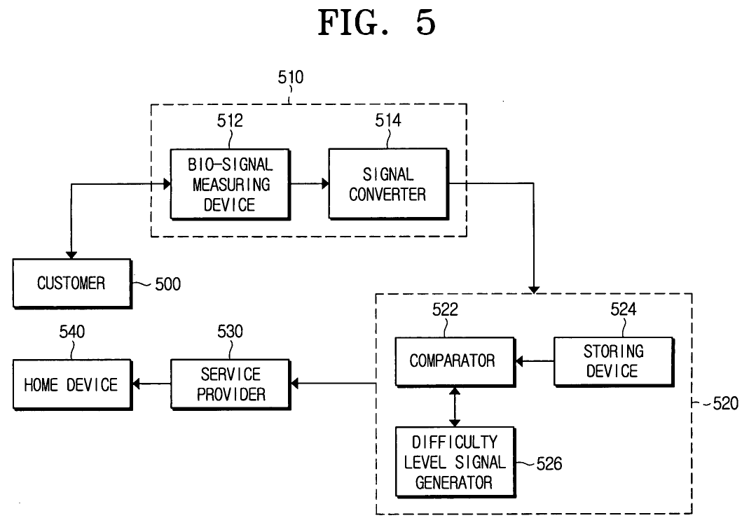

FIG. 4 illustrates how to change the difficulty level with the transferred difficulty level changing signal according to an exemplary embodiment of the invention, which is hereinafter described.

At operation S400, the service provider sets a k value, which is described in more detail below.

At operation S402, one of the difficulty level changing signals, generated in FIG. 3, is transferred to the service provider.

At operation S404, it is determined if the transferred difficulty level changing signal is a difficulty level up signal. If the transferred signal is determined to be a difficulty level up signal, the process moves to operation S406. Otherwise, the process moves to operation S408.

At operation S408, it is determined if the transferred difficulty level changing signal is a difficulty level down signal. If the transferred signal is determined to be a difficulty level down signal, the process moves to operation S410. Otherwise, the process moves to operation S412. At operation S410, the service provider compares the pre-measured comprehension level of the customer with the k value. As described above, the comprehension levels of customers are stored in the service provider. That is, one content may be composed of a plurality of sub-contents, and the comprehension level of the customer is measured and stored whenever the learning of one sub-content is finished. Table 1 is an example showing how the comprehension level of customer 1 for content A can be stored during learning.

TABLE 1

| Sub-contents | Comprehension (c) |
|---|---|
| Contents 0 | 80 |
| Content 1 | 67 |
| Content 2 | |
| . . . | |
| Content n | |

Referring to table 1, content A is composed of content 0 to content n, and customer 1 learns content 2 after finishing content 0 and content 1. The comprehension level of customer 1 is 80 for content 0 and 67 for content 1.

Therefore, if the value of k is set to 70 by the service provider, the pre-measured comprehension level (c) is found to be smaller than k (70) at operation S410. It is needless to say that the value of k is adjustable according to the setting by the service provider. Moreover, this value can be set independently for each content. As described above, operation S410 is performed in order to prevent a “ping-pong” condition due to the concentration level change of the customer, which is transmitted in real time. If the comprehension level c, measured at the previous step, is larger than the preset k value at operation S410, the process moves to operation S412. If the comprehension level c, measured at the previous step, is not larger than the preset k value, the process moves to operation S414. The service provider provides content having a difficulty level one-step higher at operation S406, while it provides content having a difficulty level one-step lower at operation S414. The service provider provides content of the same difficulty level as the current content without changing the difficulty level at operation S412.

FIG. 4 describes how to increase or decrease the difficulty level by one step, while it is also possible to increase or decrease the difficulty level by two or more steps according to the setting by the service provider. In addition, the pre-measured comprehension level for sub-contents in an exemplary embodiment is explained for comparison with the preset k value. In other words, the average of the pre-measured comprehension levels may be compared with the preset k value.

FIG. 5 illustrates a system that provides contents having a difficulty level corresponding to the learning ability of the customer according to an exemplary embodiment of the present invention. As shown in FIG. 5, the system comprises a customer 500, a detector 510, a home server 520, a service provider 530 and a home device 540. The detector 510 includes a bio-signal measuring instrument 512 and a signal converter 514, while the home server includes a comparator 522, a storing device 524 and a difficulty level signal generator 526.

The bio-signal measuring instrument 512 measures the brain waves of the customer 500 for determining the concentration level of the customer 500. The bio-signal measuring instrument 512 can be attached to the head of the customer 500 for easy measuring of the brain waves.

The signal converter 514 converts an analog signal, measured in the bio-signal measuring instrument 512, into a digital signal. The concentration level, converted into a digital signal, is transferred to the comparator 522.

The storing device 524 stores the comprehension level of each customer and a, b and k values set by the service provider 530 according to an exemplary embodiment of the invention.

The comparator 522 determines a proper region for the transferred concentration level among three regions formed by preset a and b values, and then directs the difficulty level signal generator 526 to generate a corresponding difficulty level signal. The difficulty level signal generator 526 generates a difficulty level signal corresponding to the direction of the comparator 522, then transfer the signal to the comparator 522.

The comparator 522 directs the service provider to maintain or increase the difficulty level when the transferred difficulty level signal is a difficulty level maintain signal or a difficulty level up signal. The comparator 522 also controls the service provider 530 to maintain or decrease the difficulty level if the transferred difficulty level signal is a difficulty level down signal.

The service provider 530 increases, decreases or maintains the difficulty level according to the direction of the comparator 522, then provides it to the home device 540. The home device includes a display device or an audio device. In this manner, the customer 500 can receive desired contents having a difficulty level corresponding to their learning ability.

The home server 524 provides services according to the measured concentration of the customer 500. Services for encouraging concentration can be provided if the concentration level of the customer 500 is lower than the preset value. A break for a certain time or an interesting image or sound can be provided as a service for encouraging concentration.

As described above, according to the present invention, the learning efficiency of the customer can be promoted by providing contents having different difficulty levels corresponding to the learning ability of the customer. In addition, the concentration level of the customer is measured so that the learning efficiency can be increased by providing an image or sound when the concentration level is lower than the preset value.

The foregoing embodiments and aspects are merely exemplary and are not to be construed as limiting the present invention. The present teaching can be readily applied to other types of apparatuses and methods. Also, the description of the exemplary embodiments of the present invention is intended to be illustrative, and not to limit the scope of the claims, and many alternatives, modifications, and variations will be apparent to those skilled in the art.

What is claimed is:

1. A method of providing contents in an education on demand (EOD) system, the EOD system comprising a content provider for providing contents and a home device, the method comprising:
determining a difficulty level among the contents according to an ability of a user, the contents having at least two difficulty levels; and
transmitting content to the home device which corresponds to the difficulty level which is determined.

2. The method as claimed in claim 1, wherein the determining includes:
selecting a region corresponding to the ability of the user out of two or more regions; and
generating a signal corresponding to the selected region.

3. The method as claimed in claim 2, wherein the signal corresponding to the selected region is one of a difficulty level up signal, a difficulty level down signal and a difficulty level maintain signal.

4. The method as claimed in claim 3, wherein content having a higher difficulty level than what is currently provided is provided if the signal corresponding to the selected region is a difficulty level up signal.

5. The method as claimed in claim 3, wherein the customer has a comprehension level of the content, and
wherein the content is composed of at least two sub-contents, such that the comprehension level is measured after at least one of the sub-contents is learned.

6. The method as claimed in claim 4, wherein the customer has a comprehension level of the content, and
wherein a difficulty level which is the same as the content which is currently provided is maintained if the signal corresponding to the selected region is a difficulty level down signal and the comprehension level for a previously provided content is higher than a preset value.

7. The method as claimed in claim 4, wherein the customer has a comprehension level of the content, and
wherein a difficulty level which is the same as the content which is currently provided is maintained if the signal corresponding to the selected region is a difficulty level down signal and an average comprehension level for a previously provided content is higher than a preset value.

8. The method as claimed in claim 1, wherein the ability is a learning ability.

9. The method as claimed in claim 8, wherein the learning ability includes a concentration level.

10. The method as claimed in claim 1, wherein the ability is calculated from brain waves of the user.

11. The method as claimed in claim 1, wherein the user is a customer.

12. A system for providing an education on demand (EOD) service, the system comprising:
a home server which determines a difficulty level according to an ability of a user;
a service provider which provides content, corresponding to the difficulty level which is determined, from among contents having at least two difficulty levels; and
a home device which receives the content from the service provider.

13. The system as claimed in claim 12, further including a detector for measuring a concentration level of a user, wherein the detector includes:
a bio-signal measuring instrument which measures the concentration level of the user; and
a signal converter which converts a signal, measured by the bio-signal measuring instrument, into a digital signal.

14. The system as claimed in claim 13, wherein the home server includes:
a comparator which selects a region corresponding to the digital signal from among at least three regions; and
a difficulty level signal generator which generates a difficulty level signal in accordance with the region which is selected.

15. The system as claimed in claim 14, wherein the difficulty level signal generator generates one of a difficulty level up signal, a difficulty level down signal and a difficulty level maintain signal.

16. The system as claimed in claim 15, wherein the home server directs the service provider to provide content having a higher difficulty level than that of a current content if the generated signal is a difficulty level up signal.

17. The system as claimed in claim 15, wherein the content has at least two sub-contents, and wherein the home server has a storing device in order to store a calculated comprehension level of the user after at least one of the sub-contents is learned.

18. The system as claimed in claim 17, wherein the home server directs to maintain a current difficulty level if the signal corresponding to the selected region is a difficulty level down signal, and the comprehension level for a previously provided content is higher than a preset value.

19. The system as claimed in claim 17, wherein the home server maintains a difficulty level of a currently provided content if the difficultly level signal is a difficulty level down signal, and an average comprehension level for at least one of the sub-contents, which is previously provided, is higher than a preset value.

20. The system as claimed in claim 12, wherein the ability is a learning ability.

21. The system as claimed in claim 20, wherein the learning ability includes a concentration level.

22. The system as claimed in claim 12, wherein the ability is calculated from brain waves of the user.

23. The system as claimed in claim 12, wherein the user is a customer.
